(19) United States
(12) Patent Application Publication
(10) Pub. No.: US 2012/0160130 A1
(43) Pub. Date: Jun. 28, 2012

(54) TINTING SYSTEM FOR PRODUCING A DEFINED NUMBER OF SHADES OF A PAINT READY FOR USE, INCLUDING ASSOCIATED COMPONENTS

(75) Inventor: Rainer Heubach, Grossgmain (AT)

(73) Assignee: HEUBACH GMBH, Langelsheim (DE)

(21) Appl. No.: 13/375,678

(22) PCT Filed: Jun. 1, 2010
(86) PCT No.: PCT/EP2010/057645

§ 371 Date: Mar. 13, 2012

(30) Foreign Application Priority Data
Jun. 2, 2009 (DE) 102009023606.6
Aug. 21, 2009 (DE) 102009038146.5

(51) Int. Cl. C09D 1/00; G09B 19/00

(52) U.S. Cl. 106/401; 106/436; 106/461; 106/420; 106/421; 106/493; 106/440; 106/441; 106/430; 106/456; 106/479; 106/472; 106/506; 106/499; 106/498; 106/497; 106/496; 106/410; 434/98

(57) ABSTRACT

A tinting system for producing a defined number of shades of a paint ready for use characterized by: (a) a dye set, (b) a color identification means, and (c) plurality of metering means for accommodating a shade component, and a brightening component. Each metering means being designed to manually meter the respective dye component and to exactly reproduce the number of shades defined by the color identification means.

The invention relates to a tinting system for producing an unlimited number of shades of a ready-for-use paint and the associated system components and the provision, selection and metering thereof. Furthermore, the invention relates to a method for producing a ready-for-use paint with this tinting system.

Paints are provided in a form which can be mixed together to produce various shades. The mixable paints in this case contain, on the one hand, non-chromophore ingredients in the form of binders, solvents and additives. On the other hand, they contain chromatic and achromatic dyes as chromophore ingredients, which determine the respective shade, wherein achromatic dyes are to be taken to mean dyes which give the observer a white, black or grey colour impression.

The entire spectrum of shades obtainable in this manner is made available to the user by colour identification means, which for each mixable shade, provide a colour pattern for visual selection and the associated fractions of the respective base colour and colour pastes to precisely adjust the colour. Colour identification means of this type are known in various configurations, for example in the form of conventional formulation books, colour charts or colour cards (“fan decks”) or also as corresponding computer-assisted systems (“computer colour matching”).

Painting means containing inorganic or organic pigments as the chromophore ingredients are usually called paints. In contrast to colourants, according to DIN 55943:2007, pigments are insoluble dyes in particle form, the colour impression or colour intensity of which substantially depends on the particle size and increases with a decreasing particle size.

Traditionally, paints are provided in a large number of predetermined shades for direct use. Powder pigments in liquid binders and solvents are dispersed by the paint producer in these ready-for-use paints. A homogeneous wetting of all the pigment particles with the binder and therefore a high shade consistency and good storage stability of the ready-for-use paints is reliably ensured here, in particular by the use of industrial dispersing aggregates. Although particularly high-grade paints can be made available in this manner in every desired shade and with any desired colour intensity, this availability is, however, limited for cost reasons to large container sizes and/or relatively few standard colours.

As conventional powder pigments can only be dispersed with difficulty without the use of corresponding dispersing aggregates, and indeed, in particular when the pigments to be dispersed have to be used in very small particle sizes for the purpose of a high colour intensity, reproducible and dust-free colour adjustment for small quantities and special colours has hitherto not been practical on the basis of conventional powder pigments and separate liquid dispersing media, in particular by the user himself.

The drawback in the poor dispersibility of conventional powder pigments can be overcome by using special pigment preparations, in which the powder pigments have surface-active additives added. Such so-called self-dispersing dry pigment preparations are disclosed, for example, in DE-102 44 683 A1. Although these systems are also available as system colours, the production of individual shades in small quantities and by the user himself is nevertheless ruled out as expensive dispenser systems are necessary, however, to adjust the colour with a dye set of this type.

With the known colour pastes, which are provided in the form of a dye set for mixing a special paint in any desired shade from a base colour or substrate component and a shade component, the problem of the exact metering and homogenisation does not occur for the user, as both dye set components are provided in the optimal predispersion of the pigments as liquid colours.

It is therefore made possible for the user to produce the ready-for-use paint in the desired shade by simply mixing the two dye components in optimal quality himself. However, the high price of colour pastes of his type, caused by the respective individual metering in a laboratory scale using corresponding automatic metering machines has in fact proven to be a decisive disadvantage which, in particular, rules out the use of conventional colour pastes of this type in the do it yourself (DIY) sector. The drawback for the user is moreover that the colour pastes are only obtainable in predetermined container sizes and a precise adaptation to the required quantity is not possible.

System colour pastes are already known from the prior art, for example U.S. Pat. No. 2,528,530 or U.S. Pat. No. 5,027,872, which, by mixing generally 10 to 15 liquid base colours or substrate components with colourmetrically calibrated colour pastes or shade components which are compatible with one another in full tone and with brightening, allow adjustment of a painting means in thousands of precisely predefined shades. However, the metering precision of a system according to U.S. Pat. No. 2,528,530 or a screw-on system described in U.S. Pat. No. 5,027,872 cannot be used at a point of use for a mixing colour system because of incalculable residual quantity emptying of the additives and therefore pigmenting levels that cannot be precisely established.

In U.S. Pat. No. 2,528,530, the object was directed at avoiding thickened pigment and filler deposition during relatively long storage; however, (column 19 to 25) no mechanical dispersing device, which is reliable from today's standpoint, is given apart from restricted free space and shaking, to achieve a homogeneous, ready-for-use paint even with the proposed highly flowable components. “Mixing balls” in the basic component (mixing bucket) and an inert gas filling for binder-containing components would even then have been the minimum to make this invention handleable within the limits outlined.

By combining a dye set of this type with a colour metering machine and a corresponding colour identification means to form a tinting system, the final production of each predefined shade of a ready-for-use paint can take place in the required container size by mixing the respective metered first and second components of the dye set directly in the paint shop (“point of sale”) without reductions in the adjustment quality being linked with this. Colour metering machines of this type for liquid components of dye sets are known in various configurations from the prior art. DE-10 2005 014024-A1 also discloses an example of a device of this type for metering dry preparations. Drawbacks in the aforementioned previously known tinting system are overcome by a tinting system of this type. Nevertheless, a tinting system of this type also has drawbacks, both for the retailer and for the user:

As the system colour pastes used generally have a high pigment content and therefore high colouring power, they are particularly suitable for producing ready-for-use paints in full tone colours. In order to therefore produce paints in pastel tones and, in particular in small container sizes of 0.5 kg or 1 kg, such as are conventional in the “do it yourself” sector (DIY), system colour pastes of this type are diluted with respect to colour. This generally occurs in that the white pigment fraction of the base colour or substrate colour is increased. In order to thus be able to adjust every predefined shade of a ready-for-use paint, white base colours or substrate components with a different opacity or covering power, or a different level of a titanium dioxide fraction, have to be used in a tinting system of this type. As a plurality of substrate components of this type is generally necessary for this, this leads to a high cost burden due to capital, storage and sales area commitment for the retailer. Furthermore, a complicated and expensive mechanical mixing system is required in practice for optimal reproducibility, including the environmentally polluting dead quantities in the tubes and valves to be cleaned at least once a day by means of a “cleaning programme”.

The substantial drawback in conventional colour mixing systems of this type for the user is that also full tone colours that are highly saturated in terms of colour with a high opacity or covering power can, however, owing to agglomerate formation of the chromatic pigments and poor dispersion performance of the mechanical mixing systems, exclusively be adjusted by increasing the titanium dioxide fraction, which is always linked with a brightening of the added colour pastes or colour tone components and to this extent leads to unsatisfactory mixing results.

Moreover, using automatic metering systems, which, due to the method, require the addition of titanium dioxide, no high-grade paints, in particular no high-grade paints for external use, can be produced using organic pigments, as titanium dioxide brings about a premature photocatalytic degradation of the organic pigmentation and the binder matrix and therefore substantially impairs the light and weather resistance of the paint thus dyed. Alternatives based, for example, on lithopone pigments are often rejected because of their increased metering requirement and, associated with this, disadvantageous changes in the flowability associated therewith, and also the weathering resistance can decrease, and the covering power of these white pigments does not satisfy all requirements over prolonged duration.

Overall, high additional costs are produced for the retailer through providing the metering machine, maintaining it and through operating staff required to operate it. Owing to the necessary stocking of substrate and shade components in a large number and quantity for covering the entire possible colour spectrum, high storage costs also arise.

Added to the already listed drawbacks for the user is the fact that a retrospective shade correction is ruled out owing to the final production of the ready-for-use paint in the paint shop. In other words, if it should turn out at the point of use that the selected shade does not correspond to expectations, the entire quantity of ready-for-use paint has to be discarded. In addition to the above-mentioned machine cleaning, further disposal costs or basic environmental pollution then basically occur.

These drawbacks are also not eliminated by the prior art according to the patents U.S. Pat. No. 6,531,537, U.S. Pat. No. 7,250,464 and U.S. Pat. No. 7,612,129 as the common teaching of these patents concentrates on a stationary mechanical system with a relatively high degree of complexity. The US patent U.S. Pat. No. 6,531,537 moreover optimises only addition systems for achromatic pigments or fillers especially in latex-based binder systems for producing a white or slightly brown toned base paint or a “substrate component” according to the teaching of our invention and accordingly dispenses with control systems for selecting and checking colour sets formulated close to application. Accordingly, U.S. Pat. No. 7,250,464 included in the same patent family, deals with the formulation of achromatic primer and first coat paints for the purpose of optimising rheological and covering properties.

Furthermore, U.S. Pat. No. 6,531,537 and U.S. Pat. No. 7,250,464 B2 focus on the production of relatively large filling units of said paints in complex, and, according to the figures, preferably stationary and host computer-controlled manufacturing plants.

U.S. Pat. No. 7,612,129 claims a colour adjustment, but according to the teaching of this patent, “colour” according to claim 5 and also according to the examples is above all taken to mean “white”. Apart from in the case of titanium dioxide, listed under “pigment” are only substances, which in specialist terms would actually have to be called “fillers”. The patent, above all, has, as the object, the fully computer-controlled adjustment of one or more control cycles of various fillers, flow improvers, dispensing aids, thickeners and binders on an automatic production plant, in order to thereby achieve certain flow, coating and surface properties.

The products, which this and the other patents of this patent family intend to manufacture in an optimised manner, could be used as substrate components in the present invention.

US 2007/0116867 A1 and WO 2008/012848 are based on ready-made metering sizes in the solid state, such as colourant tablets or pouches, but here primarily in tablet and powder form. U.S. Pat. No. 7,166,667 leads further into the production of base colours on the basis of ready-made solids, but, as in the aforementioned patent family of the same Applicant, does not teach any adjustment of chromatic shades and furthermore uses complex colour mixing systems, which rather correspond to the “point-of-sale” of a building centre, but which are to be avoided at the point of use.

Alternative metering systems are furthermore known from the documents U.S. Pat. No. 2,528,530, U.S. Pat. No. 2,663,461, EP 1830946 A1, EP 2045209, DE 10 2004 030155 A1, DE 10 2007 001 140 A1, DE 10 2007 061371 A1 and DE 7519756 U1, but which do not eliminate some or all of the disclosed defects of the prior art
High dead volumes with increasing waste quantities with reducing application volumes
High degree of complexity of a mixing device
Stationary, over-sized mixing systems, which cannot be handled by untrained people
Poor and non-reproducible residual degree of emptying of ready-made metering means
Poor reproducibility when carried out by untrained or non-specialist people
Lack of correctability despite known composition at the point of use.

There is a need to disclose a colour mixing system including chromatic colours, which allows simple and economical final production of qualitatively high-grade, ready-for-use paints in a large number of precisely adjustable shades with a high quality by means of the user directly at the point of use (POU), which is also suitable for use in the “do it yourself” (DIY) sector and which still allows a reproducible shade change at the point of use. For this purpose, a tinting system according to the invention is to provide suitable dye sets and colour identification means. Furthermore, it is the object of the invention to provide a method for producing the ready-for-use paints with this tinting system. Furthermore, advantageous uses are to be disclosed for the use of the proposed colour mixing system.

The above-mentioned complex object, on which the invention is based, is addressed by the subjects of claims 1 to 22. These relate to a dye set, a colour identification means, a tinting system, a method for producing a ready-for-use paint with a tinting system and the use of special piston syringes for mixing the components of the tinting system. The independent claims 1, 7, 11, 20 and 22 firstly form the basis for this. Advantageous configurations emerge from the claims referring back thereto. In this regard in detail:

The subject of the invention is first of all a dye set for producing a ready-for-use paint in a large number of shades, having (a) at least one substrate component with non-chromophore achromatic and chromophore chromatic ingredients, for providing a base colour, and (b) at least one shade component with, in each case, non-chromophore achromatic and chromophore chromatic ingredients, for mixing with the substrate component for the purpose of subtractive colour mixing, wherein the dye set further contains at least one brightening component (c) with non-chromophore achromatic and chromophore chromatic ingredients for mixing with the substrate component and each respective shade component to produce the ready-for-use paint in a shade, wherein the tinting ingredients adjusting the covering power and/or the basic brightness comprise less than 40 per cent by volume of each substrate component, more than 5 and less than 75 per cent by volume of each shade component and more than 50 per cent by volume of each brightening component. According to the aim, by combining the components a+b, a+c, b+c, apart from the aforementioned combination a+b+c, ready-for-use, tinted colours can be produced therewith without specialist prior knowledge at the point of use. A mixing and redispersal takes place here manually or by means of conventional domestic small machines with a simple and conventional stirring device. Advantageous embodiments of this dye set emerge from claims 2 to 6.

The subject of the invention is also a colour identification means for establishing a defined number of shades of a ready-for-use paint from mixable components of a dye set and the respective associated metering of each dye set component, wherein the colour identification means for establishing the defined number of shades of the ready-for-use paint is formed from a substrate component, at least one shade component and a brightening component, each defined shade being established by a colour pattern and information on the associated volume fractions of the substrate component, each shade component and brightening component for adjustment. Advantageous embodiments of the colour identification means according to the invention emerge from claims 8 to 10.

A particular subject of the present invention is a tinting system for producing a defined number of shades of a ready-for-use paint, which is characterised by: (a) a dye set according to at least any one of claims 1 to 6; (b) a colour identification means according to at least any one of claims 7 to 10; and (c) a first metering means for receiving the substrate component, a second respective metering means for receiving each shade component and a third metering means for receiving the brightening component, each metering means being formed for the manual metering of the respective dye component and for the precise reproduction of the number of shades defined by the colour identification means. Advantageous embodiments of the tinting system according to the invention emerge from claims 12 to 19.

Furthermore, a method for producing a ready-for-use paint with a tinting system according to claim 11 is also to be associated with the invention, which is characterised by the consecutive method steps: (a) selecting a shade from the defined number of shades of the ready-for-use paint and the associated metering of the substrate component, each shade component and the brightening component of the dye set with the colour identification means; (b) providing each corresponding dye component in the corresponding metering means for producing a defined total volume of the selected shade of the ready-for-use paint; (c) manual metering of each provided dye set component from the corresponding metering means to mix for the production of the selected shade; (d) producing the defined total volume of the selected shade of the ready-for-use paint by mixing all the provided dye set components. A method of this type is advantageously developed by the features of claim 21.

Finally, the invention is to comprise the use of syringes with a cylindrical housing with a measurement graduation and a displaceably mounted piston and/or cups with an, in particular transparent, in particular cylindrical housing with a measurement graduation and a foil lid or reclosable lid as the metering means in a method for producing a defined number of shades of a ready-for-use paint, from a substrate component, at least one shade component and a brightening component of a tinting system according to at least any one of claims 11 to 19, in particular claim 17, wherein the metering means, to provide the substrate component, has a first useful volume, each metering means, to provide one of the shade components, has a constant second useful volume, and the metering means, to provide the brightening component, has a third useful volume. The third useful volume is preferable larger than the first and the second useful volume. The respective measurement graduation is preferably provided for metering each dye set component.

The following statements are to be used for further description of the invention and its various technical configurations:

In the tinting system according to the invention, the spectrum of the adjustable shades of the ready-for-use paint is produced by a dye set with a total of one or more dye components, which each have a specific fraction of chromophore ingredients, whereas only dye sets with two dye set components are known from the prior art, namely a substrate component and a shade component, which also do not have the fractions of chromophore ingredients required to achieve the object according to the invention.

No tinting system with a colour identification means is known from the prior art, which has metering information for each respective one of three dye set components of the type according to the invention for the exact adjustment of a ready-for-use paint in a shade from a defined number of possible shades. Finally, the prior art also does not know the use of a respective manual metering means for each of the three dye set components according to the invention for the given purpose.

As the volume fractions of the chromophore ingredients of the three dye set components are provided in the manner according to the invention and the provision and precise meterability of each dye set component takes place by means of the use according to the invention of manual metering means, in accordance with the metering information predetermined in each case by the colour identification means according to the invention the final production of a shade of the ready-for-use paint can take place directly at the point of use (POU) of the paint, in a simple and economical manner, with high quality and directly by the user.

The tinting system according to the invention is also excellently suited for use in the do it yourself sector, as it allows the production of a ready-for-use paint in small container sizes in any desired predefined shade. Owing to the use provided by the invention of the manual metering means in conjunction with the colour identification means, the user also has the possibility of firstly preparing a smaller quantity of the ready-for-use paint in the selected shade, which is sufficient to check the colour effect of the originally selected shade in situ, without the remaining dye set components being unusable if they do not please, but they do form the basis of the final production of a large number of further shades which can easily be adjusted by means of the colour identification means.

Furthermore, the tinting system according to the invention, owing to the displacement of the final production of the ready-for-use paint from the point of sale to the point of use, allows considerable cost savings for the paint trade, in that the provision and maintenance of an expensive metering machine become superfluous and in that the storage costs are also substantially reduced by the substantially smaller number of dye set components to be stocked. In total, the advantages mentioned of the tinting system according to the invention are also suitable for increasing the user satisfaction, or customer satisfaction, due to the direct and more user friendly access to qualitatively high-grade paints from a broad spectrum of possible shades.

Compared to automatic machine-based methods, in which all the dye set components are provided in containers of the same type and which consequently, for example, depend on the use of titanium dioxide for shade adjustment, there is no limitation of any kind in the method according to the invention with regard to the form and useful volume of the manual metering means used. On the one hand, it is therefore possible to also use other brightening components as an alternative to titanium dioxide in order, for example, to produce paints with improved light and weather stability. On the other hand, owing to the manual metering according to the invention and the metering means provided for this, but also, above all, the precise adjustment according to the invention on the basis of the dye specification, a ready-for-use paint is made possible in every one of the shades defined by the colour identification means, using a single substrate component.

Since in the method according to the invention, metering means with a different useful volume are used for each dye set component and the provision of the brightening component takes place in a metering means with a larger useful volume, account is taken of the possibility of adjusting each of the shades of the ready-for-use paint defined by the colour identification means using only a single substrate component.

Carrying out the method according to the invention with only a single substrate component has the advantage compared to the prior art that only the brightening component has to be stocked in large-volume metering containers and therefore significantly lower storage costs accrue in comparison.

Advantages of the tinting system according to the invention compared to conventional tinting colours and conventional dispenser systems consist in the reproducible metering by means of simple technical aids. In addition, the combination of different dye additive components allows the reproducible adjustment according to the invention of a large diversity of shades, such as can also be achieved with conventional dispensers with a higher outlay, the shades being able to be picked out in advance from a plurality of different colour charts.

Advantages of the tinting system according to the invention compared to conventional dispenser systems therefore emerge as follows: reduction in the purchasing costs for machines, an increase in the flexibility, an increase in the cost-efficiency and reduction in the travel times for the workmen.

Advantageous embodiments of the invention have already been dealt with above in conjunction with reference to the dependent claims. The following application principles and examples are therefore more descriptive in this regard.

On the one hand, the use of this system as a supplement (for example for special application areas or following a trend) is possible, but exclusive use is also conceivable. The colour range, which it was also possible to achieve to date with conventional systems is achievable, but with significantly lower costs.

Principle 1: a conventional commercial syringe filled with a pigment preparation is clamped in a piece of equipment, as, for example, according to the figures. The crank handle is turned with the injection nozzle open until paste comes out and the crank handle locks in place. The paste which has escaped until then is removed and the metering can take place according to the formulations. The metered quantity can be monitored by a counter in the case of larger metering quantities.

Principle 2: similar to principle 1, but with the difference that an empty syringe is clamped in and a defined volume is drawn out by the equipment from a paste holder/pouch. In this case, the volume is checked by means of the counter, which counts each time there is a latching into place and is finally completely dispensed.

Principle 3: as in principle 2, but the spindle can be exchanged on the equipment for a spindle with a changed pitch, so the metered volume can thus be varied with a full rotation. Exchanging the syringe for a syringe with a changed volume (see figure) as the preferred metering means would have the same effect.

All the principles have in common that a formulation is presented for the desired shade. The customer has two possibilities here. He can select the shade from a conventional commercial colour chart and receives the associated metering quantities from an electronic data processing device over the internet or from a formulation book. Another possibility is a special colour chart which provides the formulations.

When describing the above principles, a syringe was mentioned, which is suitable to advantageously apply the tinting system according to the invention. Reference is made in this regard to the following figures, in which:

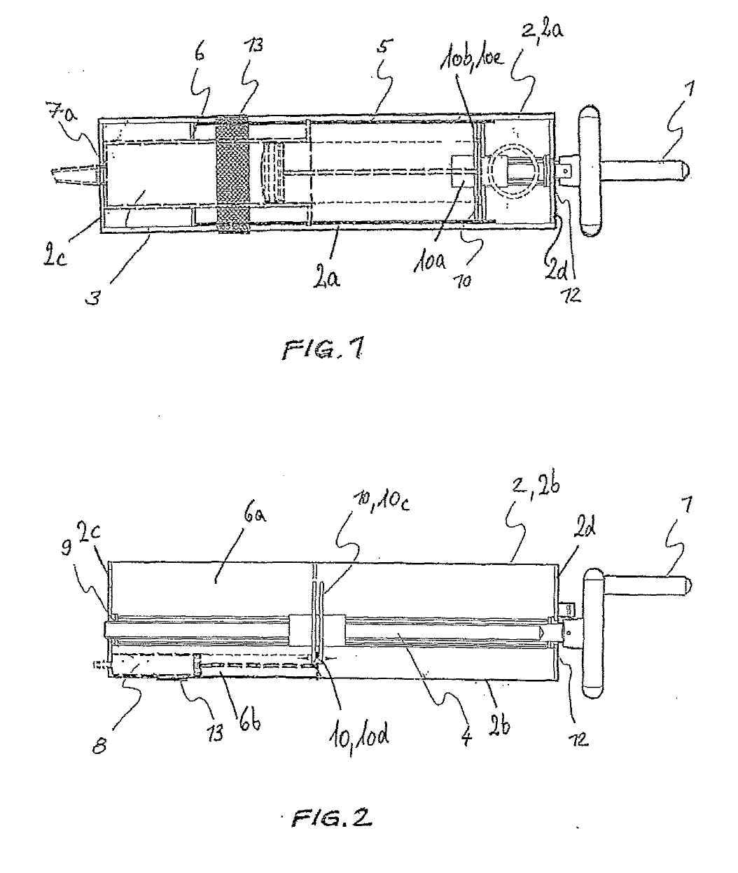

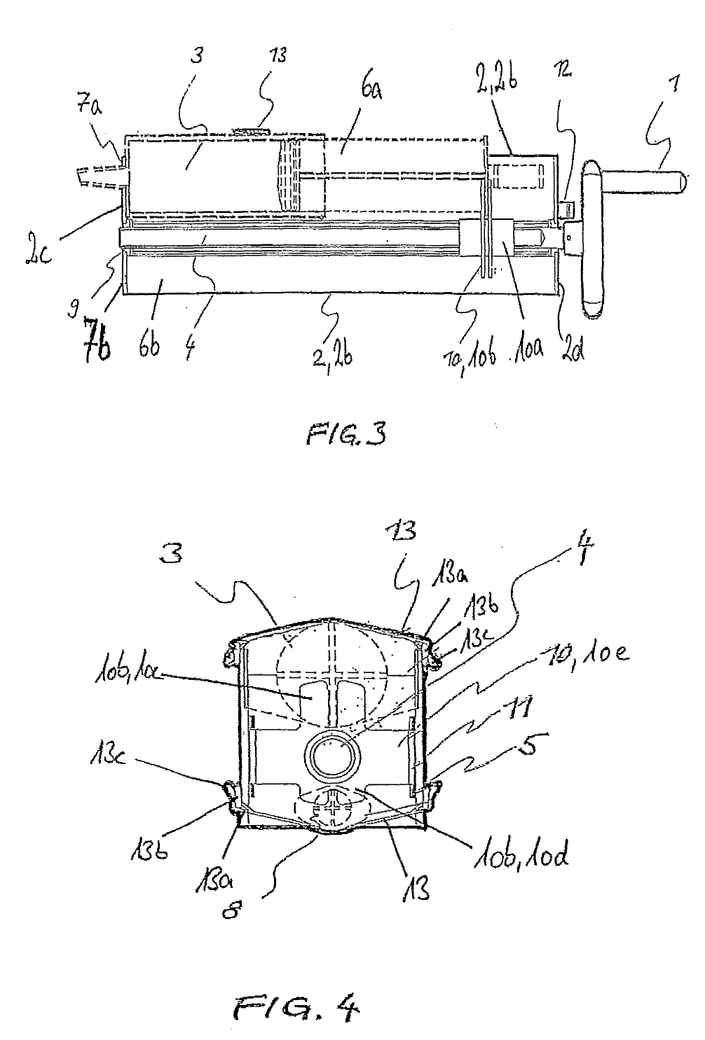

FIGS. 1, 2 and 3 show a holding mechanism to receive a 100 ml syringe and a 5 ml syringe, in each case of a conventional mode of construction, in particular in a plan view (FIG. 1) and in a side view (FIGS. 2 and 3).

FIG. 4 shows a holding mechanism according to the above FIGS. 1 to 3 in cross-section.

FIG. 1 shows a plan view of the holding mechanism for syringes according to a preferred but not restrictive embodiment, which is particularly suitable for use in conjunction with the tinting system according to the invention. The holding mechanism or metering device comprises a housing 2, which, for example, can be configured as a stainless steel housing. The housing 2 may also comprise a plastics material. The housing 2 has two closed sides 2a, arranged opposite, which are coupled to one another at axial end faces of the holding mechanism by end plates 2c, 2d. Two further sides of the housing 2, arranged opposing, are configured as open sides 2b. The housing 2 thus forms, in plan view, as shown in FIG. 1, a substantially rectangular hollow profile.

Also arranged at the open sides 2b is a fixing means 13, which spans the open side 2b, at least partially. In particular, the open side 2b is substantially completely spanned by the fixing means 13 in the transverse direction. In the axial direction, the fixing means 13 partially extends over the length of the open side 2b. The fixing means 13 is preferably configured elastically. For example, the fixing means 13 comprises a rubber strap. The fixing means 13 is, or can be, furthermore detachably connected to at least one closed side 2a. The fixing means 13 is preferably detachably connected to both closed sides 2a, so that the fixing means 13 can be removed to insert a syringe 3, 8 and can be clamped over the open side 2b or the syringe 3, 8 to fix the syringe 3, 8.

The holding mechanism furthermore comprises a threaded spindle 4, which is arranged substantially centrally between the closed sides 2a of the housing 2. The threaded spindle 4 extends here from the front end plate 2c to the rear end plate 2d and is rotatably mounted in the end plates 2c, 2d. For this purpose, the end plates 2c, 2d in each case comprise a spindle bearing 9. The spindle bearing 9 is preferably configured as a pressure and radial bearing, for example as a tapered roller bearing. The spindle bearing 9, in particular the pressure and radial bearing, may comprise Teflon.

The threaded spindle 4 is connected to a crank handle 1 in the region of the rear end plate 2d. The crank handle 1 may, for example, comprise a star knob. In general, the threaded spindle 4 may be coupled to an actuating element, which allows a rotation of the thread spindle 4 about its own longitudinal axis. The rotation of the threaded spindle 4 may take place manually or in an automated manner. For example, the threaded spindle 4 may be rotationally driven by the crank handle 1 or a motor.

As also shown in FIG. 1, the threaded spindle 4 is preferably connected to the crank handle 1 by a ball ratchet 12. The ball ratchet 12 may comprise a graduation of 360°. The ball ratchet 12 allows easy handling of the holding mechanism or metering device, the crank handle 1 being prevented from automatically turning back.

The threaded spindle 4 furthermore comprises a driver 10 which has a screw mounting on the threaded spindle 4 or a screw connection to the threaded spindle 4.

The driver 10 has a threaded sleeve 10a, which comprises an internal thread, in which the threaded spindle 4 engages. Furthermore, the driver 10 comprises an insertion means 10b, which comprises two plates arranged parallel to one another, which are arranged at a spacing from one another. The threaded sleeve 10a and the insertion means 10b are preferably connected to one another in one piece. In this case, the insertion means 10b is advantageously arranged centrally on the threaded sleeve 10a, as shown, for example, in FIG. 2.

The insertion means 10b in this case comprises an upper portion 10c and a lower portion 10d, the upper portion 10c extending further from the threaded spindle 4 than the lower portion 10d. The upper portion 10c and the lower portion 10d in each case comprise a central slot, which extends substantially parallel to the closed sides 2a of the housing 2.

The two slots are preferably arranged aligned with one another and adapted to receive a cross-shaped syringe piston. This configuration can be seen, in particular, from FIG. 4, which shows a cross sectional view through the holding mechanism according to FIGS. 1 to 3. It can also be seen there that the insertion means 10b, or in general the driver 10, comprises two side portions 10e, arranged opposite, which are displaceably mounted in sliding rails 5, the sliding rails 5 being arranged on the inner faces of the closed sides 2a of the housing 2. The sliding rails 5 preferably have a low-friction material. For example, the sliding rails 5 may comprise Teflon. Analogously to this, it may be advantageously provided that the side portions 10e of the driver 10 have corresponding sliding faces, which are low-friction, in particular comprising Teflon.

The holding mechanism or metering device comprises, in general, two syringe holders 6a, 6b, a large syringe holder 6a and a small syringe holder 6b preferably being provided. The upper portion 10c of the driver 10 or the insertion means 10b, in this case, is associated with the large syringe holder 6a, whereas the lower portion 10d of the insertion means 10b is associated with the smaller syringe holder 6b. It is particularly preferred if the large syringe holder 6a is adapted to receive a large syringe 3 and the small syringe holder 6b is adapted to receive a small syringe 8. The large syringe 3 preferably comprises a syringe volume of at least 80 ml, in particular at least 90 ml, in particular at least 100 ml. The small syringe preferably has a syringe volume of at most 50 ml, in particular at most 20 ml, in particular at most 10 ml, in particular at most 5 ml.

As shown in FIG. 1, the holding mechanism or metering device in the region of the front end plate 2c may comprise a half shell-like connection 6 between the closed sides 2a. The half shell-like connection may have a curvature, which is adapted to the radius of the syringe 3, 8. The half shell-like connection thus forms a support or insert for syringes 3, 8. It is provided here that the curvature of the half shell-like connection 6 extends in the direction of the threaded spindle 4.

The front end plate 2c furthermore comprises a large feedthrough 7a and a small feedthrough 7b. The feedthroughs 7a, 7b are in each case arranged centrally here with respect to the respective syringe holder 6a, 6b. In particular, the large feedthrough 7a is associated with the large syringe holder 6a, so that a large syringe 3 inserted in the large syringe holder 6a engages with its tip through the large feedthrough 7a. Analogously to this, a tip of a small syringe 8 engages through the small feedthrough 7b when the small syringe 8 is arranged in the small syringe holder 6b.

To fix the syringes 3, 8, the fixing means 13 is provided, which according to FIG. 4, on the side edges, comprises a loop 13a, in each case, which is connected to an eyelet 13b. The eyelet 13b can furthermore be connected to the closed sides 2a of the housing 2, in that the eyelet 13b can be coupled to a hook 13c.

The mode of functioning of the holding mechanism or metering device will be described below:

Syringes 3, 8 are inserted in the syringe holders 6a, 6b, the cross-shaped syringe pistons being positively connected to the insertion means 10, in particular the upper portion 10c or lower portion 10d. A rear end of the syringe piston in this case engages in the free space between the two parallel plates, which form the insertion means 10b. The syringes 3, 8 are stationarily fixed in the syringe holders 6a, 6b, whereas the syringe pistons can be driven, i.e. are axially displaceable by means of the connection to the insertion means 10b or to the driver 10 by means of the threaded spindle 4. Owing to the small graduation of the ball ratchet 12, an exact feed movement of the syringe piston is possible here, in particular a torque is applied to the threaded spindle 4 by means of the crank handle 1, whereby the driver 10 is axially displaced. The syringe piston connected to the driver 10 is also axially moved, whereby either the substance arranged within the syringe 38 is conveyed out of the tip of the syringe 38 or an external substance is drawn into the syringe.

It is possible to at the same time insert a large syringe 3 and a small syringe 8 into the holding mechanism or metering device. Alternatively, a large syringe 3 or a small syringe 8 may in each case be arranged in the metering device. FIG. 2 shows a side view of the holding mechanism or metering device with the small syringe 8 inserted, in particular with a syringe with a 5 ml filling volume. FIG. 3 shows the metering device with a large syringe 3, in particular a 100 ml syringe in a side view.

The reference numerals that can be seen from FIGS. 1 to 4 receive the significance that can be seen from the following list of reference numerals.

The elements of the described positions 4 and 10 can be designed as replacement parts in order to achieve a more rapid or slower volume displacement per rotation, for example in the case of highly viscous pastes. In the case of slow strokes, the bubble formation is avoided when filling the syringe. The following details are still to be given for an advantageous configuration with respect to the two designated syringes: volume displacement upon 1 revolution (using an M16 thread with a 2 mm pitch in each case) about 2 ml in the 100 ml syringe and about 0.2 ml in the 5 ml syringe.

### EXAMPLE 1

### Supplement to an Existing Paste System

The conventional dispensers are frequently occupied and a supplementation by further preparations is not easy to carry out. The use according to the invention of the metering syringe may be a simple supplementation for preparations here, which either extend the colour range, represent a different type of supplementation for special technical requirements or replace problematic pastes in a system during preparation.

### EXAMPLE 2

### Exclusive Metering By Means of This System

Simplicity and the low cost factor make it possible to replace conventional tinting systems in the DIY sector if they do not operate profitably. A further possibility is using it at the painter's premises, who can produce its qualities for the contract site himself at the appropriate time and in a reproducible manner. The private customer can also profit from this by obtaining ready-filled metering means or buying the equipment or borrowing it.

### EXAMPLE 3

### Correction of a Shade at the Contract Site

Not infrequently, the shade appears different on a larger surface or the ideas of the customer differ from the result. In this case, an adjustment can take place in a reproducible manner.

### LIST OF REFERENCE NUMERALS

1 crank handle, in particular star knob with crank handle
2 housing, in particular stainless steel housing
2a closed side
2b open side
2c front end plate
2d rear end plate
3 large syringe, in particular 100 ml syringe
4 threaded spindle, in particular thread M16 with 2 mm pitch
5 guide rail, in particular Teflon guide rail
6 half shell-like connection, in particular half shell holder for syringes
6a large syringe holder
6b small syringe holder
7a large feedthrough, in particular through-hole for syringe
7b small feedthrough, in particular through-hole for syringe
8 small syringe, in particular 5 ml syringe
9 spindle bearing, in particular pressure and radial bearing for example made of Teflon
10 driver, in particular for syringe
10a threaded sleeve
10b insertion means
10c upper portion
10d lower portion
10e side portion
11 sliding face, in particular Teflon sliding face on the driver
12 ball ratchet, in particular with 360° graduation
13 fixing means, in particular rubber strap for fastening the syringe
13a loop
13b eyelet
13c hook

1. A dye set for producing a ready-for-use paint in a large number of shades comprising:
(a) at least one substrate component with non-chromophore achromatic and chromophore chromatic ingredients for providing a base colour, gained in a cup comprising a re-closable lid
(b) at least one shade component with non-chromophore achromatic and chromophore chromatic ingredients, for mixing with the substrate component for the purpose of subtractive colour mixing, gained in a syringe comprising a transparent, cylinder-shaped body with a scale and comprising a movable piston for metering,
(c) at least one brightening component with non-chromophore achromatic and chromophore chromatic ingredients for mixing with the combined substrate component and each respective shade component to produce the ready-for-use paint in a shade, and tinting achromatic ingredients, for adjusting the covering power and/or the basic brightness of the ready-for-use paint, said tinting achromatic ingredients comprising less than 40 per cent by volume of each substrate component, more than 5 and less than 75 per cent by volume of each shade component and more than 50 per cent by volume of each brightening component.

2. A dye set according to claim 1, characterised in that the tinting achromatic ingredients comprise pigments selected from the group consisting of: inorganic pigments titanium dioxide pigments, barium sulphate, zinc sulphide, zinc oxide and lithopone; fillers having brightening properties; and black pigments for darkening, modified carbon blacks, mixed phase metal oxide pigments, spinels or inverse spinels.

3. A dye set according to claim 1, characterised in that the chromophore chromatic ingredients comprise pigments selected from the group consisting of inorganic pigments, organic pigments, mixed phase metal oxide pigments, chromatic spinel pigments, doped titanium dioxide-based light brown pigments, inorganic yellow pigments, nickel-antimony-titanium yellow, chromium-antimony-titanium yellow, tin-zinc-titanium oxide, stabilised iron oxides, bismuth vanadate derivates, cerium sulphide, diketopyrrolopyrrols, perylenes, benzimidazolone pigments, quinophthalone pigments, quinacridones, isoindolinone pigments, indanthrones, dibromanthanthrones, dioxazines, phthalocyanine derivates and mixtures thereof.

4. A dye set according to claim 1, characterised in that the non-chromophore achromatic ingredients comprise a dispersing medium, dispersing additives and non-tinting fillers.

5. A dye set according to claim 4, characterised in that said substrate component and said shade component each comprise anti-settling agents.

6. A dye set according to claim 1, characterised in that the ready-for-use paint is selected from the group consisting of: a liquid paint, a dispersion paint for internal and external paints, a floor paint, an industrial gloss paint or artist's paint.

7. A colour identification means for establishing a defined number of shades of a ready-for-use paint from mixable components of a dye set according to any one of the preceding claims and a respective associated metering of each dye set component, said means comprising: a substrate component, at least one shade component and a brightening component, with each defined shade being established by a colour pattern and information on an associated volume fractions of the substrate component, the shade component and the brightening component.

8. A colour identification means according to claim 7, comprising a colour chart with a plurality of chart sheets, each chart sheet comprising a colour pattern and information on the associated volume fractions of the substrate component, each shade component and the brightening component being associated with a shade of the defined number of shades.

9. (canceled)

10. A colour identification means according to claim 7, comprising at least one analogue storage medium or at least one digital storage medium, wherein such storage medium contain data to display the colour pattern and the associated volume fractions of the substrate component, the shade component and the brightening component associated with each defined shade for application-ready and use-ready reproduction.

11-22. (canceled)
